(19) United States
(12) Patent Application Publication
(10) Pub. No.: US 2025/0170946 A1
(43) Pub. Date: May 29, 2025

(54) Mobile Bunkhouse Trailer

(71) Applicant: Jag Mobile Solutions, Inc., Howe, IN (US)

(72) Inventor: William L. Gibson, Angola, IN (US)

(21) Appl. No.: 19/039,928

(22) Filed: Jan. 29, 2025

Related U.S. Application Data
(63) Continuation-in-part of application No. 18/482,104, filed on Oct. 6, 2023.
Application No. 18/482,104 is a continuation of application No. 17/683,900, filed on Mar. 1, 2022, now Pat. No. 11,801,786.
(60) Provisional application No. 63/154,844, filed on Mar. 1, 2021.

(51) Int. Cl. B60P 3/38

(52) U.S. Cl. CPC B60P 3/38

(57) ABSTRACT

A bunkhouse trailer is provided that includes a plurality of bunk bed assemblies. The trailer has a plurality of modular removable interior barrier walls defining isolated living spaces between the lower and upper beds in each of the bunk bed assemblies. The individual accommodations for each user eliminates shared spaces where surface contamination may lead to disease transmission. In some embodiments, the modular removable interior barrier walls can be configured to form a bunk room having between one and four individual bunks.

### RELATED APPLICATION

This application is a continuation-in-part of U.S. patent application Ser. No. 18/482,104 filed Oct. 6, 2023 for a “Mobile Bunkhouse Trailer,” which is a continuation of U.S. patent application Ser. No. 17/683,900 (Now U.S. Pat. No. 11,801,786) filed Mar. 1, 2022 for a “Mobile Bunkhouse Trailer,” which claimed the benefit of U.S. Provisional Application Ser. No. 63/154,844 filed Mar. 1, 2021 for a “Mobile Bunkhouse Trailer,” each of these applications are hereby incorporated by reference in their entireties.

### TECHNICAL FIELD

This disclosure relates generally to a bunkhouse trailer; in particular, this relates to a bunkhouse trailer with a plurality of individual interior spaces that are movably isolated from each other to reduce the risk of disease spreading between users.

### BACKGROUND

A bunkhouse trailer includes a one or more sets of bunk beds. Although bunk beds increase the accommodations for the trailer, the users have needed to share common spaces. While this shared arrangement may be suitable in some circumstances, there can be risks associated with shared accommodations. For example, there is a risk of infectious diseases and/or germs being spread between occupants of the trailer due to the shared spaces. In such a situation, persons sharing a space may contaminate the shared space for the other occupants, both in terms of touching surfaces and sharing air within the space.

Therefore, there is a need for a bunkhouse trailer with a plurality of isolated, interior spaces for occupants to stay. Additionally, there exists the need for modularity in a bunkhouse trailer to accommodate cabins of different sizes.

### SUMMARY

According to one aspect, this disclosure provides a trailer with a trailer body defining an interior space. The trailer includes a bunk bed assembly within the interior space such that the bunk bed assembly comprises a lower bed and an upper bed. There are a plurality of barrier walls defining a first individual space that includes the lower bed and a second individual space that includes the upper bed. The trailer has a first door movably attached to the trailer body to access the first individual space and a second door movably attached to the trailer body to access the second individual space. The plurality of barrier walls prevent air flow between the first individual space and the second individual space, thereby isolating the first individual space and the second individual space from each other.

According to another aspect, this disclosure provides a trailer with a trailer body defining an interior space. The trailer includes a plurality of bunk bed assemblies within the interior space such that each of the plurality of bunk bed assemblies include a lower bed and an upper bed. There are a plurality of barrier walls associated with each of the plurality of bunk bed assemblies, wherein the plurality of barrier walls define isolated interior spaces between the lower bed and the upper bed for each of the plurality of bunk bed assemblies. A first exterior door is provided that is movably attached to the trailer body to access a first individual space associated with the lower bed defined by the plurality of barrier walls. The trailer also includes a second exterior door movably attached to the trailer body to access a second individual space associated with the upper bed defined by the plurality of barrier walls. The plurality of barrier walls prevent air flow between the first individual space and the second individual space, thereby isolating the first individual space and the second individual space from each other.

According to yet another aspect, this disclosure provides a trailer with a trailer body defining an interior space. The trailer includes a plurality of bunk bed assemblies within the interior space such that each of the plurality of bunk bed assemblies include a lower bed and an upper bed. There are a plurality of barrier walls associated with each of the plurality of bunk bed assemblies, wherein the plurality of barrier walls define isolated interior spaces between the lower bed and the upper bed for each of the plurality of bunk bed assemblies. The plurality of barrier walls are removably attached to the trailer body. The interior space comprises four individual bunk beds which are separated by four removable internal trailer walls. The internal trailer walls can be configured to provide, optionally, four rooms with one bed in each room, two rooms with two beds in each room, two rooms with one bed in one room and three beds in another room, three rooms with two beds in one room and one bed in each of the other rooms, and one room with four beds in it.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a left side view of an example trailer according to an embodiment of this disclosure;

FIG. 2 is a right side view of the example trailer shown in FIG. 1;

FIG. 3 is a front view of the example trailer shown in FIG. 1;

FIG. 4 is a rear view of the example trailer shown in FIG. 1 with at least a portion of the step assemblies in an extended position;

FIG. 5 is a left side perspective view of a portion of the interior space of the example trailer shown in FIG. 1;

FIG. 6 is a right side perspective view of the interior space shown in FIG. 5;

FIG. 7 is a top view of the example trailer shown in FIG. 1 with the roof removed to expose the floor plan;

FIG. 8 is the example floor plan shown in FIG. 7 with an example ducting layout shown in ghost;

FIG. 9A shows an example configuration of an example trailer configured to have four rooms each with one bunk bed;

FIG. 9B shows an example configuration of an example trailer configured to have three rooms with two bunk beds in one room and one bunk bed in each of the other rooms;

FIG. 9C shows an example configuration of an example trailer configured to have two rooms with three bunk beds in one room and one bunk bed in the other room;

FIG. 9D shows an example configuration of an example trailer configured to have one room with four bunk beds;

FIG. 10 shows a front view of an example interior wall panel of the example trailer of FIG. 9A;

FIG. 11 shows a front perspective view of an example interior wall panel of the example trailer of FIG. 9A;

FIG. 12 shows a left side view of an example interior wall panel of the example trailer of FIG. 9A;

FIG. 13 shows an upper perspective view of an example interior of an example trailer room configured to have one bunk bed;

FIG. 14 shows a perspective view of an example interior of an example trailer room configured to have one bunk bed opposite to the example interior of FIG. 13;

FIG. 15 shows a lower perspective view of an example interior of an example trailer room configured to have one bunk bed;

FIG. 16 shows a perspective view of an example interior of an example trailer room configured to have two bunk beds;

FIG. 17 shows an upper perspective view of an example interior of an example trailer room configured to have three bunk beds;

FIG. 18 shows a lower perspective view of an example interior of an example trailer room configured to have three bunk beds; and

FIG. 19 shows a perspective view of an example interior of an example trailer room configured to have four bunk beds.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural features may be shown in specific arrangements. However, it should be appreciated that such specific arrangements may not be required. Rather, in some embodiments, such features may be arranged in a different manner than shown in the illustrative figures. Additionally, the inclusion of a structural in a particular figure is not meant to imply that such feature is required in all embodiments and, in some embodiments, may not be included or may be combined with other features.

This disclosure generally relates to a trailer that provides individual accommodations for a plurality of persons in which each individual accommodation is isolated from the other accommodations of the trailer. Although the example trailer described herein is configured to provide accommodations for 12 persons, the trailer could accommodate more or less persons depending upon the circumstances. In some embodiments, this disclosure solves a technical problem of creating individual, isolated spaces for a plurality of persons to reduce the risk of cross-contamination between the individuals that are staying in the trailer. For example, in some embodiments, each individual space within the trailer has individual air return vents that are spaced apart remote from fresh air intake vent(s) to reduce the risk that return air will contaminate fresh air introduced into the individual spaces. Likewise, since each person has an individual accommodation, only the user assigned to a specific space will touch the surfaces within that particular space. Additionally, the trailer includes modular inner walls which can be selectively removed in order to create accommodations for groups of individuals, such as families. The walls are secured with a plurality of bolts that can be removed or installed once the trailer is delivered to a location.

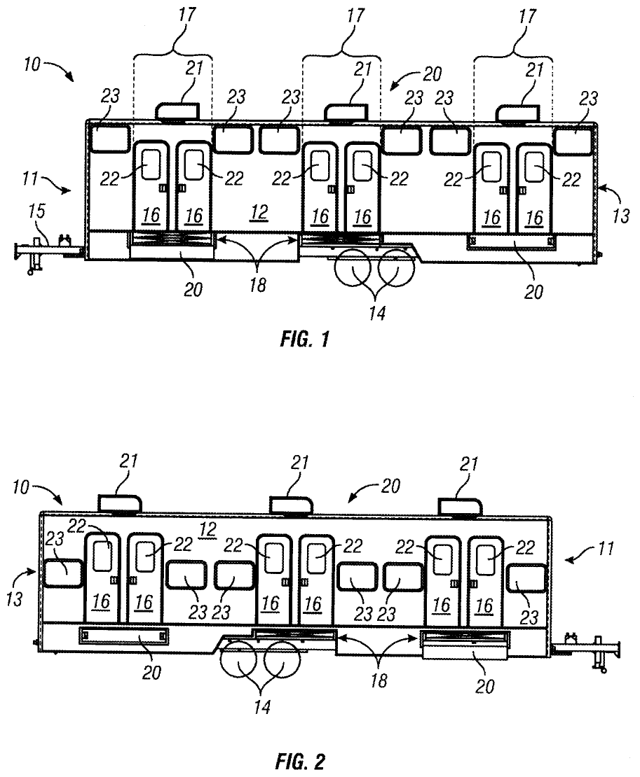

FIG. 1 is a left side view of an example trailer 10 that can provide individual, isolated accommodations for 12 persons. As shown, the trailer 10 includes a front end 11 and a rear end 13. In the example shown, the trailer 10 includes a trailer body 12 that defines an interior space. As shown, the trailer 10 includes a plurality of wheels 14 for moving the trailer 10 between various locations. For example, as shown, the trailer 10 includes a tongue 15 that could be connected with a vehicle for hauling the trailer 10 to various destinations. Although the example trailer 10 includes a tongue 15 for purposes of example, the term “trailer” is broadly intended to encompass both a transport device that needs to be hauled and a transport device that is part of the vehicle itself, such as a motor home, which does not need a separate vehicle to be hauled.

In this example, there are a plurality of doors 16 for entering the individual interior spaces. As shown, there are six doors for entering the interior spaces—one for each individual space within the trailer 10. In the embodiment shown, the doors 16 are grouped in pairs 17 that are in close proximity so a single set of steps 18 may be used with each pair of doors 16. Of course, depending on the circumstances, each door 16 could have a separate set of steps 18 for entering into that particular door 16.

As shown, the steps 18 are movable between a retracted position as shown in FIG. 1 and an extended position shown in FIG. 4. In some cases, the steps 18 may be covered by a door 20 in the retracted position to prevent contaminates from entering into the steps 18 while the trailer 10 is being transported. A user can climb the steps 18 to transition between the ground and the door 16. As shown, the doors 16 may include windows 22 for each individual interior space to provide light. In some cases, there may be an optional window 23 for each individual space to provide additional light within the space. In addition to light, the window 23 provides a secondary emergency egress point to exit each room. This means that if the door 16 is blocked or obstructed, the window 23 for the individual space with provide a second way of egress in an emergency situation. In this manner, each individual space provides at least two ways of egress, one with the door 16 and the other with the window 23. Although this example shows the window 23 on the side wall, the window 23 could be in another external wall or ceiling to provide a secondary emergency egress point. Additionally, although a window is shown for purposes of example, other emergency egress devices could be used, such as a secondary egress door or hatch.

Also shown in FIG. 1 is a plurality of HVAC units 21 mounted to the roof that may be configured to control temperature and climate within the interior spaces of the trailer 10. As discussed herein, the HVAC units 21 are configured to introduce a positive pressure within each individual space so air is continuously being expelled out of return vents. With the return vents remote from the fresh air intake for the HVAC units 21, this prevents cross contamination of air between the individual units within the trailer 10.

FIG. 2 illustrates the right side of the trailer 10. As can be seen, similar to the left side shown in FIG. 1, there are a plurality of doors 16 from which a user may enter each individual space within the trailer 10. In the example shown, there are six doors on the right side of the trailer 10 because there are six individualized spaces that can be accessed from the right side of the trailer 10 for a total of 12 individual interior spaces within the trailer 10 in the example shown. Of course, if the trailer 10 were configured with a different number of individual interior spaces, the number of doors would change accordingly.

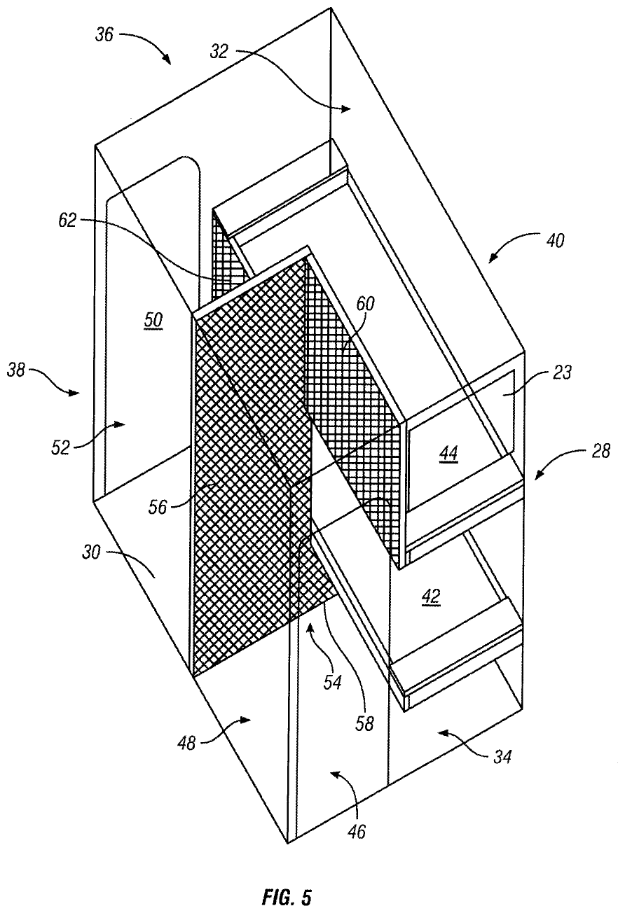

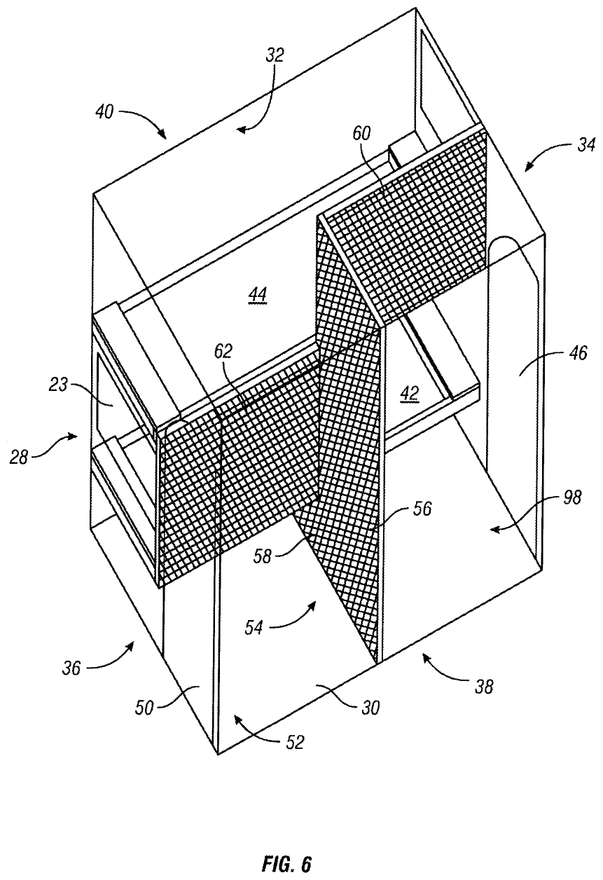

As with the left side of the trailer 10, the right side includes a plurality of steps 18 from which a user can transition between the ground and the elevated trailer floor. Likewise, in the example shown, there are a plurality of windows 23 to provide light to the interior of each individual interior space. In the example shown, the windows 23 may be positioned vertically based on the position of bunk beds within the trailer 10. For example, the window 23 on one side may be positioned above the upper bunk bed and the window 23 on the other side may be positioned between the upper and lower bunk bed (See FIGS. 5 and 6).

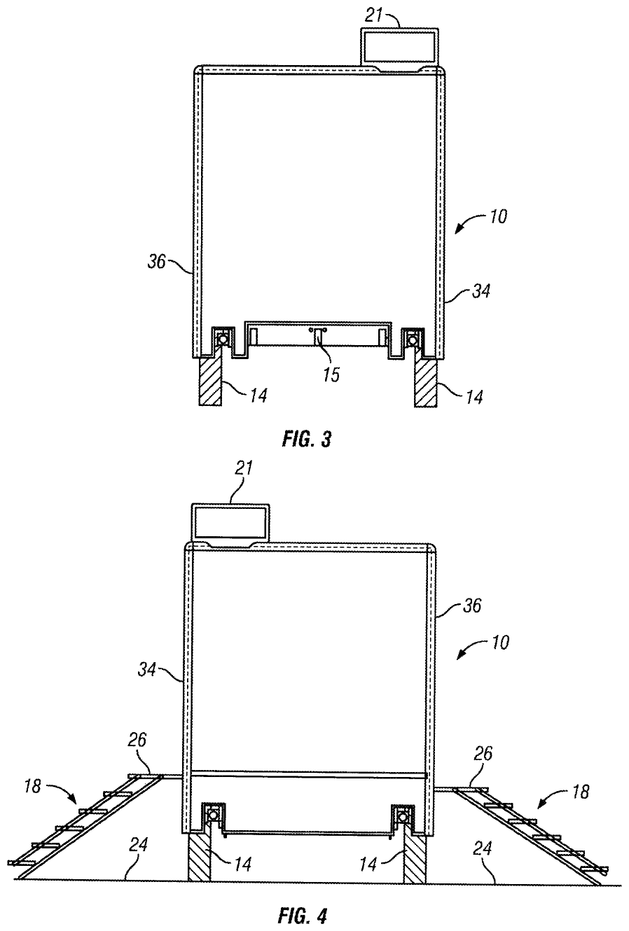

FIG. 3 is a front view of the example trailer 10 shown in FIGS. 1-2. In this view, the tongue 15 for hauling the trailer 10 can be seen. Likewise, the wheels 14 for moving the trailer 10 can be seen. As shown, one of the HVAC units 21 can be seen. In the example shown, the HVAC unit 21 is offset on one side mounted to the roof of the trailer 10 based on the ducting configuration of the interior of the trailer 10. Of course, the exact position of each HVAC unit 21 could vary depending on the circumstances. Likewise, the number of HVAC units 21 could vary depending on the circumstances.

FIG. 4 illustrates a rear view of the example trailer 10 shown in FIGS. 1-2. In the example shown, the steps 18 are illustrated in the extended position. In this position, a user may transition from the ground 24 to a platform 26 for transitioning to the floor of the trailer 10 using the steps 18. An example of retractable steps that could be used with the trailer 10 is shown in U.S. Pat. No. 10,525,891 filed Feb. 4, 2019 for a “Trailer Step Assembly,” which is hereby incorporated by reference. As shown, there is a set of steps 18 extending on each side of the trailer 10 so users can access doors 16 on either the left or right sides of the trailer 10.

FIGS. 5-6 illustrate a portion of the trailer 10 in which a set of bunk beds 28 are positioned such that each person has an individual space for each respective bed. As discussed herein, the example trailer 10 includes individual accommodations for 12 persons so the trailer 10 includes 6 sets of bunk beds in this example. However, more or less sets of bunk beds could be provided depending on the circumstances.

In the example shown, the interior space for each set of bunk beds 28 includes a floor 30, a ceiling 32, a first exterior wall 34, a second exterior wall 36, a first side wall 38, and a second side wall 40. The set of bunk beds 28 includes a lower bed 42 and an upper bed 44. As shown, the person with access to the lower bed 42 is walled off from the person with access to the upper bed 44; accordingly, the person using the accommodations with the lower bed 42 cannot touch any surfaces of the person using the upper bed 44, and vice versa. As discussed herein, each individual space (e.g., separate space for lower bed 42 and upper bed 44 accommodations) has separate air return vents 76 (See FIG. 8), which are remote from fresh air intake vents for the HVAC units 21. Additionally, the HVAC units 21 may be configured to continuously put the accommodations under positive pressure to constantly move air out of the individual units. In this manner, the air within the accommodations for the lower bed 42 is separated from the air for the upper bed 44 so there is no shared air between the accommodations for the lower bed 42 and the accommodations for the upper bed 44.

In the example shown, there is shown a first door 46 on the first exterior wall 34 for entering a first individual space 48 and a second door 50 on the second exterior wall 36 for entering a second individual space 52. As shown, the first individual space 48 has access to the lower bed 42 and the second individual space 52 has access to the upper bed 44. As shown, a window 23 is provided on the first exterior wall 34 above the upper bed 44 to provide light into the second individual space 52 and a window 23 is provided on the second exterior wall 36 between the beds 42, 44 to provide light into the first individual space 48. As discussed herein, the doors 46, 50 may optionally include windows to let additional light into the spaces 48, 52.

As shown, there are a plurality of barrier walls separating the first individual space 48 and the second individual space 52. As shown, a first barrier wall 54 separates the first individual space 48 and the second individual space 52 along an axis transverse to a longitudinal axis of the beds 42, 44. In the example shown, the first barrier wall 54 includes a first portion 56 that extends from the floor 30 to the ceiling 32 between the first side wall 38 and the side of the beds 42, 44 not connected to the second side wall 40. As shown, the first barrier wall 54 includes a second portion 58 that extends between the floor 30 and the bottom of the lower bed 42 all the way between the first side wall 38 and the second side wall 40.

As shown, there is a second barrier wall 60 that extends from the bottom of the upper bed 44 to the ceiling 32 between the first exterior wall 34 and the first barrier wall 54. Additionally, there is a third barrier wall 62 that extends from the lower bed 42 to the upper bed 44 between the second exterior wall 36 and the first barrier wall 54. With this arrangement, the barrier walls 54, 60, and 62 isolate the first individual space 48 from the second individual space 52. The barrier walls 54, 60, and 62 are made from material that prevents air from passing therethrough, such as metal, wood, plastic, drywall, etc. In some cases, there may be scaling between the barrier walls 54, 60, 62, side walls 38, 40, and/or exterior walls 34, 36 to prevent air flow between the first individual space 48 and the second individual space 52. The sealing could be embodied as any sealant that could block fluid flow (e.g., air flow) between the first individual space 48 and the second individual space 52, including but not limited to a seal caulk, silicone caulk, sealing tape, scaling putty, etc.

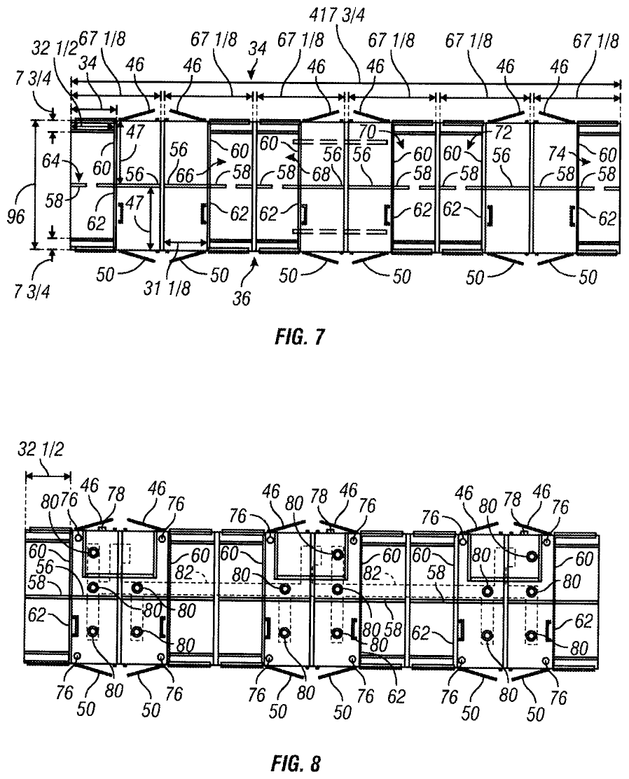

Referring now to FIG. 7, there is shown an example floor plan for the trailer 10 to accommodate up to 12 persons with six sets of bunk beds. In the example floor plan shown, there is a first set of bunk beds 64, a second set of bunk beds 66, a third set of bunk beds 68, a fourth set of bunk beds 70, a fifth set of bunk beds 72, and a sixth set of bunk beds 74. Each set of bunk beds 64, 66, 68, 70, 72, and 74 includes a lower bed and an upper bed so there is accommodations for 12 persons in this configuration. The barrier walls 54, 60, and 62 would have a similar configuration as shown in FIGS. 5 and 6 to isolate the accommodations for each set of bunk beds.

FIG. 8 illustrates an example ducting layout for the floor plan shown in FIG. 7. In this example, there are three HVAC units 21 corresponding to the ducting layout shown; however, as discussed herein, there may be more or less HVAC units 21 depending on the circumstances.

In the example shown, each of the individual spaces includes a return vent 76 for expelling air out of each individual interior space. The return vents 76 are remote from the fresh air intake vent 78 so that the air expelled from the return vents 76 is not introduced into the fresh air intake vents 78. For example, the return vents 76 could be mounted to the floor so air is expelled underneath the trailer 10 while the fresh air intake vents 78 could be installed near the ceil, which is physically remote from the return vents 76. Here, there are three fresh air intake vents 78 due to use of three HVAC units 21, but more or less fresh air intake vents 78 could be provided depending on the circumstances.

As shown, there are a plurality of supply vents 80 that supply conditioned air from the HVAC units 21. In this example, several of the supply vents 80 are fluidly connected with ducting 82 so that conditioned air is supplied within each individual space. As discussed herein, the HVAC units 21 may be configured to continuously supply air within the individual spaces to create a positive pressure environment to reduce the risk of cross-contamination with other spaces.

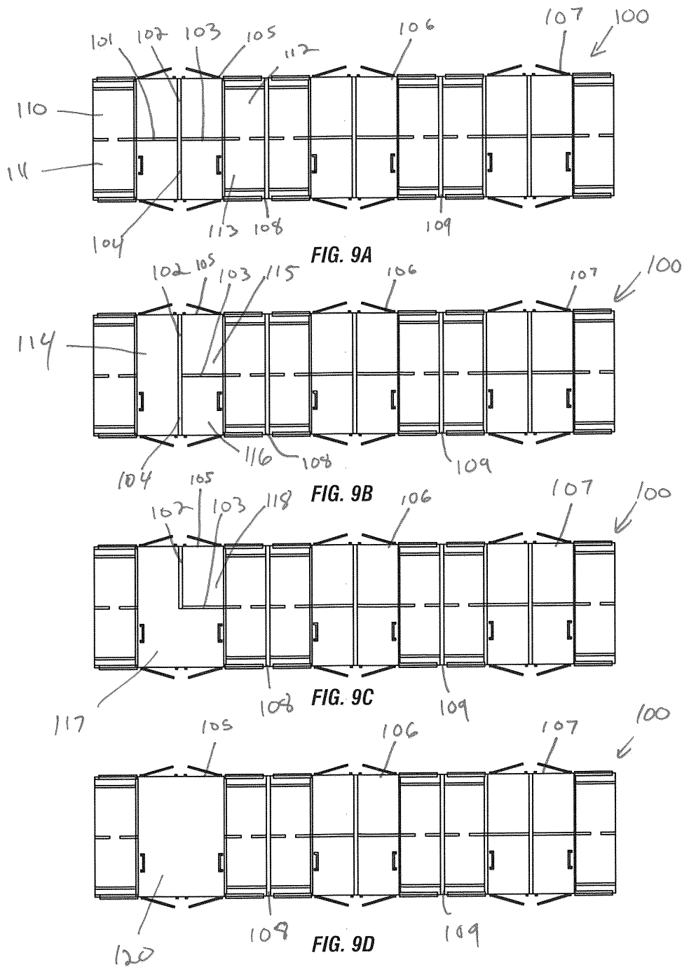

Turning next to FIGS. 9A-9D, another embodiment of a modular bunkhouse trailer 100 is shown in which the interior walls are configurable to adjust how many individual spaces or rooms are provided. Although a bunkhouse with multiple individual spaces can be desirable in some circumstances, there can be situations where accommodations for groups of two or more need or desire common spaces. For example, consider a situation where a family of four needs accommodations. There can be challenges accommodating that family in four individual spaces, particularly a family with young children. In that example, the parents would want a common space to monitor the safety of their young children. Likewise, for a couple, it may be desirable to share a common space that accommodates two instead of two individual spaces. However, there are technical issues in adapting a bunkhouse trailer to accommodate both individual spaces, along with common spaces suitable for groups of two or more.

In the embodiment shown by FIG. 9A, the modular bunkhouse trailer 100 comprises three individual bunkrooms 105, 106, 107. The embodiment shown herein is offered as an example configuration of the modular bunkhouse trailer 100. It is understood that in other or the same embodiments, there may be more or less individual bunkrooms 105, 106, 107 in the modular bunkhouse trailer 100. As shown, each of these individual bunkrooms 105, 106, 107 is separated by a non-movable internal wall 108, 109. In this example, the individual bunkrooms 105, 106, 107 each comprise four individual spaces each separated by a plurality of movable internal walls 101, 102, 103, 104 (four walls in each bunkroom 105, 106, 107 in this example) The four individual spaces separated by a plurality of individual walls can be also be seen in FIG. 7 wherein the walls are not removable. It is understood that the movable internal walls 101, 102, 103, 104 (four walls in each bunkroom 105, 106, 107 in this example) shown in individual bunkroom 105 of FIGS. 9A-D are also present in bunkrooms 106 and 107, but lead lines have been omitted for clarity.

As shown, the movable internal walls 101, 102, 103, 104 are configurable to be removed to create a bunkroom comprising a variable number spaces to accommodate not only individual spaces, but spaces for groups of two or more. Although this embodiment shows four movable internal walls 101, 102, 103, 103, one or more of the movable internal walls 101, 102, 103 could be non-movable depending on the circumstances. Likewise, in some embodiments, only a portion of the bunkrooms 105, 106, 107 could have movable walls 101, 102, 103.

FIGS. 9A-9D show example configurations of the movable internal walls 101, 102, 103. FIG. 9A shows a configuration of the modular bunkhouse trailer 100 in which the movable internal walls 101, 102, 103, 104 within the individual bunkroom 105 are all installed, thereby creating four separate rooms each with a single bed 110, 111, 112, 113. Turning next to FIG. 9B, the internal wall 101 in the bunkroom 105 has been removed, thereby providing three separate rooms 114, 115, 116. Movable internal walls 102, 103, 104 remain in the modular bunkhouse trailer 100 in this embodiment. With this configuration, the individual bunkroom 105 is configured to have a two bed suite 114 and two single bed suites 115, 116. This configuration allows for a two-person group to have a private bunkroom in the two bed suite 114 while still allowing for two individuals to stay in the two single bed suites 115, 116.

FIG. 9C shows a configuration of the modular bunkhouse trailer 100 with the movable internal wall 104 removed from the bunkroom 105 without removing walls 102, 103. In this configuration, the bunkroom 105 has two separate rooms 117, 118. The individual bunkroom 105 is configured to have a three bed suite 117 and a single bed suite 118. This configuration allows for a group of three people to have a private accommodation in the three bed suite 117 while still allowing an individual to stay in the single bed suite 118 and remain isolated from the group.

Turning next to FIG. 9D, the bunkhouse trailer 100 is configured with all four movable internal walls 101, 102, 103, 104 removed to have one room 120. In this configuration, the individual bunkroom 105 is configured to have one four bed suite 120. This configuration allows for a group of four to have a private accommodation as they are isolated from the next individual bunkroom 106 in this embodiment.

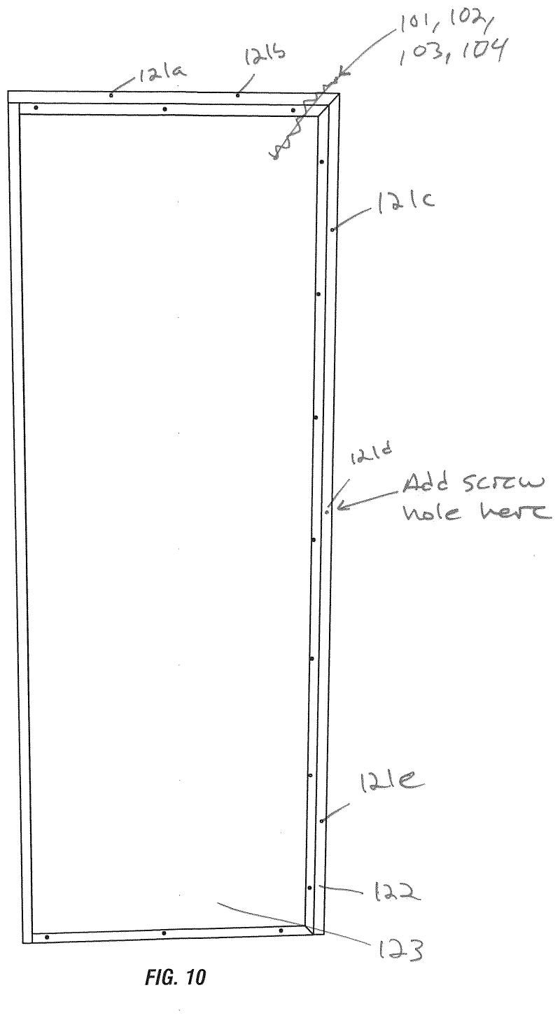

FIG. 10 shows an example embodiment of one of the movable internal walls 101, 102, 103, 104 of FIGS. 9A-9D. As shown, the movable internal walls 101, 102, 103, 104 have a center panel 123 surrounded by a lip 122. The lip 122 contacts the modular bunkhouse trailer 100 along predefined grooves (not shown) to secure the movable internal walls 101, 102, 103, 104 to the modular bunkhouse trailer 100 in varying configurations, such as those illustrated in FIGS. 9A-9D. In the embodiment shown, the lip 122 includes fasteners, such as the five screws 121a-e shown, which are used to secure the movable internal walls 101, 102, 103, 104 to the modular bunkhouse trailer 100. When configuring the modular bunkhouse trailer 100, in some embodiments with only a few fasteners, such as screws 121a-e, the reconfiguration time and associated labor costs can be reduced. The movable internal walls 101, 102, 103, 104 may optionally be constructed of any suitable material, including but not limited to, polymers, metals, metal alloys, wood, sheetrock, and the like.

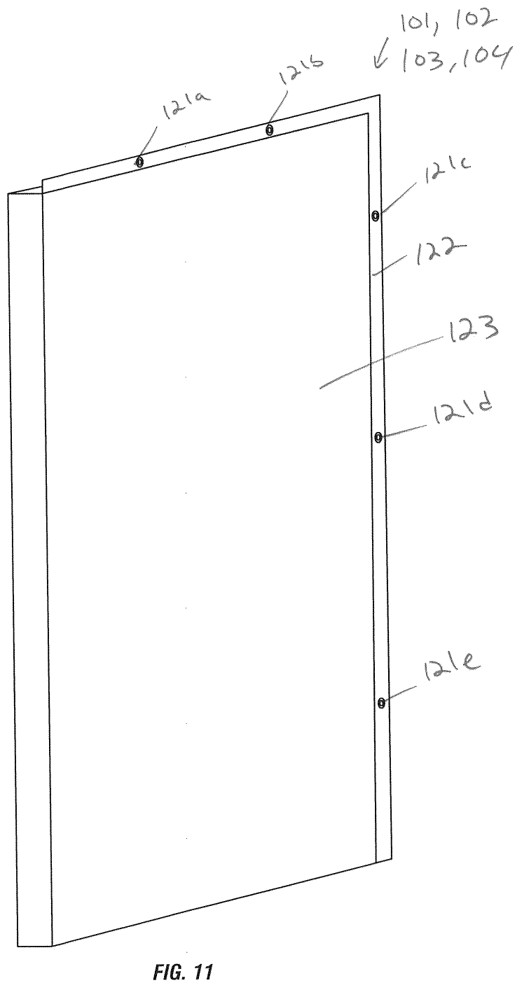

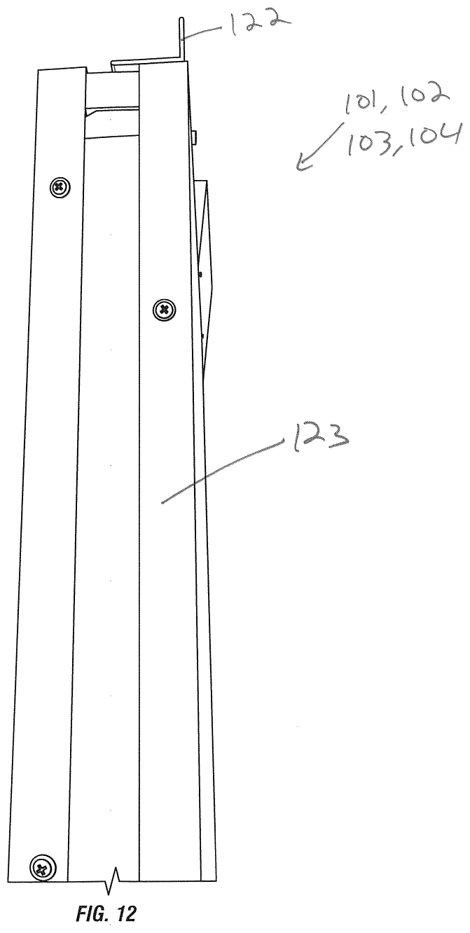

FIG. 11 illustrates an embodiment of the movable internal walls 101, 102, 103, 104 to show the lip 122 in further detail. The lip 122 comprises five screws 121a-e which are used to secure the movable internal walls 101, 102, 103, 104 to the modular bunkhouse trailer 100. In some optional examples, the lip 122 may further comprise a gasket or gasket material (not shown) to improve the seal between the movable internal walls 101, 102, 103, 104. FIG. 12 shows additional detail on the lip 122 of the movable internal walls 101, 102, 103, 104. The lip 122 may optionally be formed from a length of angle iron or aluminum. The lip 122 encircles two out of four sides of the center panel 123. The bottom of the center panel 123 does not require a lip 122 as it rests on the floor and one vertical side of the center panel 123 does not require a lip 122 as it abuts the other vertical sides of the movable internal walls 101, 102, 103, 104 in the center of the individual bunkrooms 105, 106, 107.

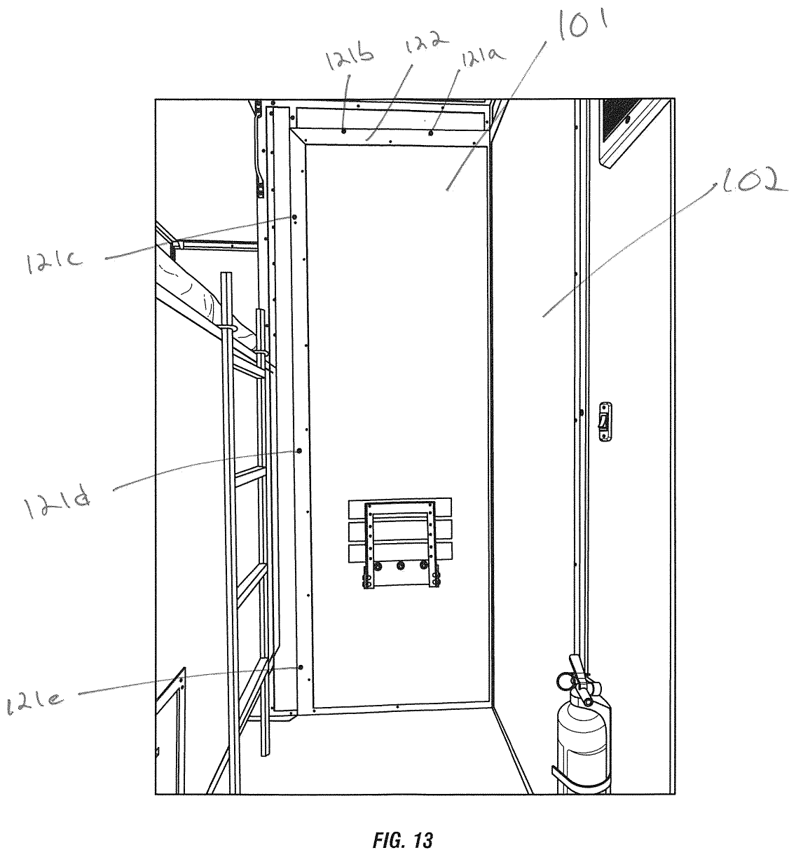

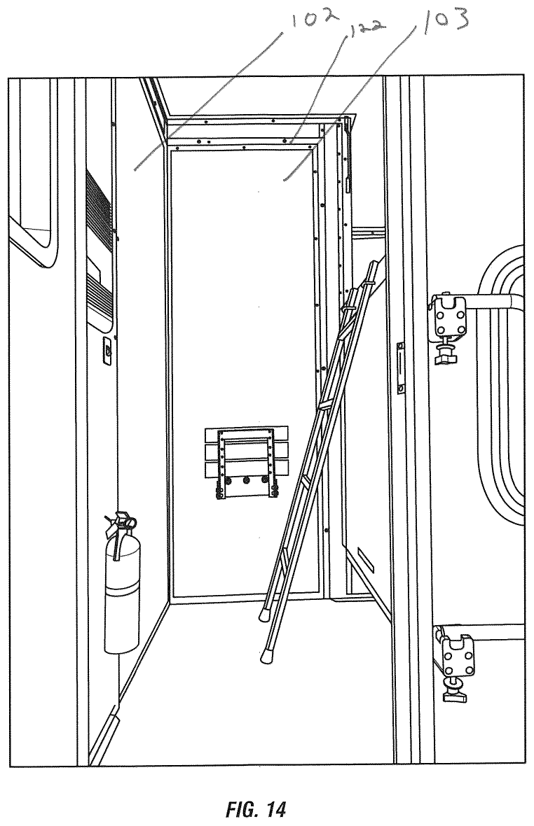

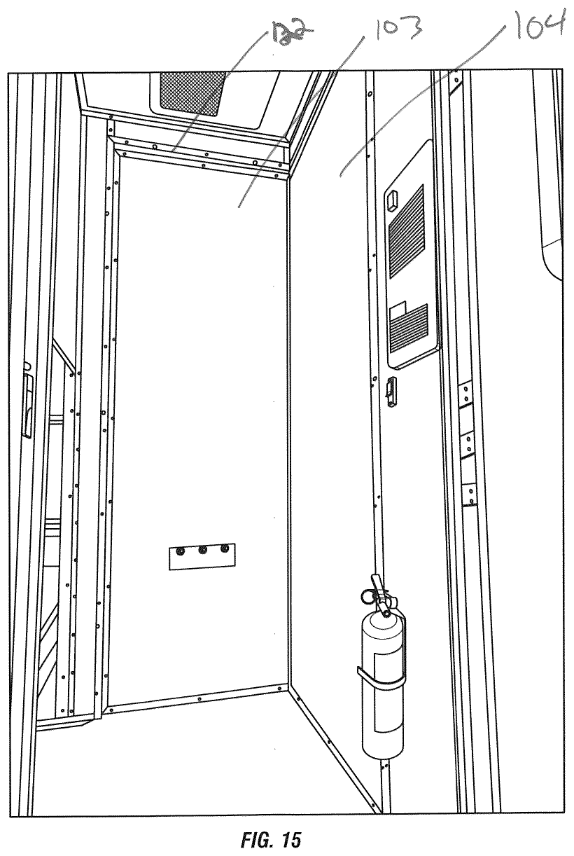

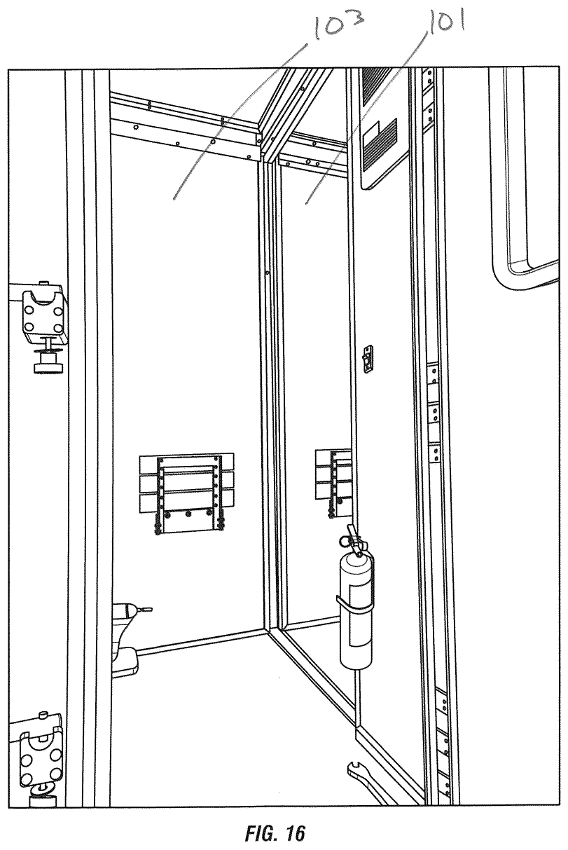

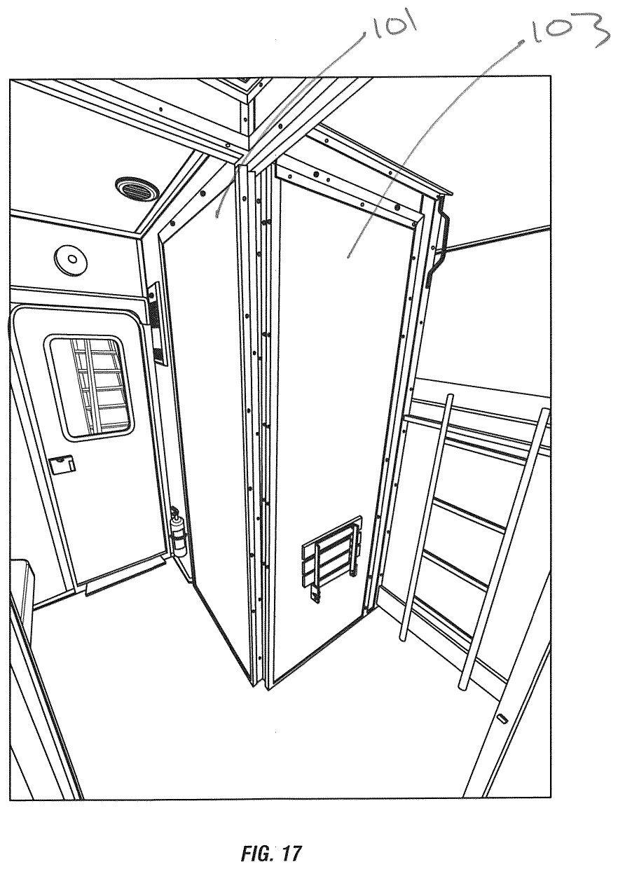

Turning next to FIG. 13, movable internal walls 101, 102 are shown installed in the modular bunkhouse trailer 100. The lip 122 surround the center panel 123 can be seen. The plurality of screws 121a-e contained within the lip 122 are securing the movable internal walls 101, 102 to the modular bunkhouse trailer 100. The configuration shown in FIG. 13 shows a single bed suite. FIG. 14 shows the opposite side of the modular bunkhouse trailer 100 of FIG. 13, which shows another single bed suite configuration. Movable internal walls 102, 103 are shown separating the beds of the modular bunkhouse trailer 100 into single bed suites. FIG. 15 shows the back side of the single bed suite configuration of FIGS. 13-14. The movable internal walls 103, 104 are shown separating the modular bunkhouse trailer 100 into four separate single bed suites. This allows for four individuals to remain isolated during sleep.

FIG. 16 shows an example embodiment of the modular bunkhouse trailer 100 where movable internal wall 102 has been removed and movable internal walls 101 (not shown), 103, and 104 remain in place. The individual bunkroom 105 is configured to have a two bed suite 114 and two single bed suites 115, 116. This configuration allows for a two-person group to have a private bunkroom in the two bed suite 114 while still allowing for two individuals to stay in the two single bed suites 115, 116.

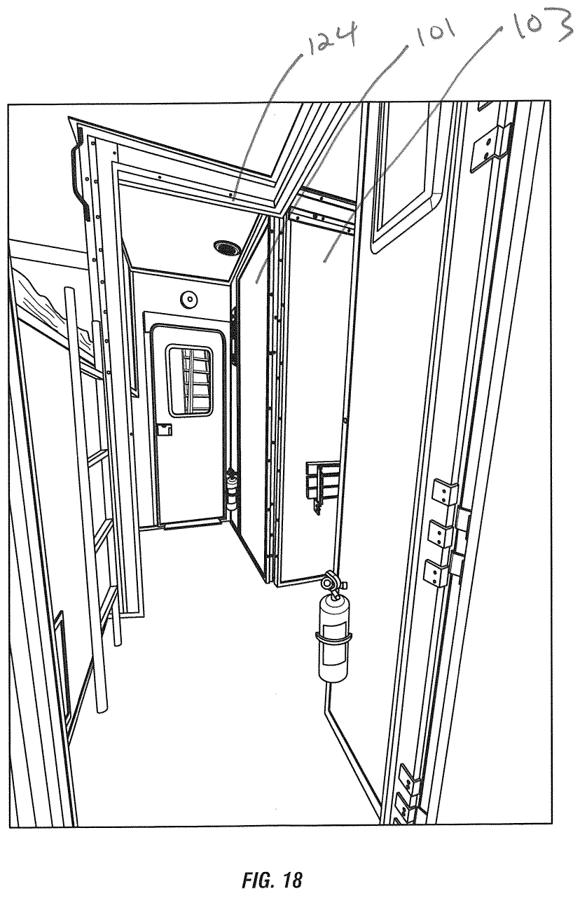

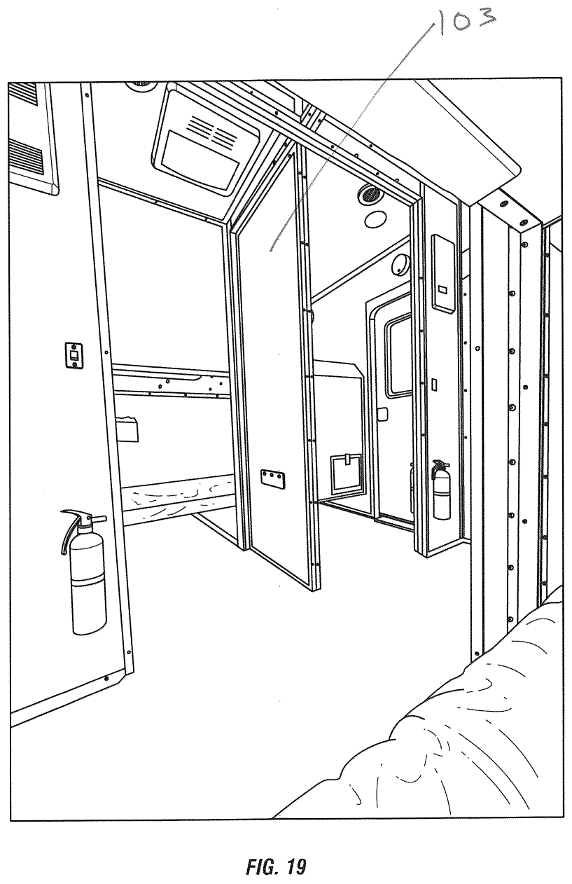

FIG. 17 shows an example embodiment of the modular bunkhouse trailer 100 where movable internal walls 102 and 104 have been removed and movable internal walls 101 and 103 remain. The individual bunkroom 105 is configured to have a three bed suite 117 and a single bed suite 118. This configuration allows for a group of three people to have a private accommodation in the three bed suite 117 while still allowing an individual to stay in the single bed suite 118 and remain isolated from the group. FIG. 18 shows an example embodiment of the modular bunkhouse trailer 100 where movable internal walls 102 and 104 have been removed and movable internal walls 101 and 103 remain as an individual would view it walking into the modular bunkhouse trailer 100. FIG. 18 further shows grooves 124 in the modular bunkhouse trailer 100 which the lip 122 of the movable internal walls 101, 102, 103, 104 fits into to secure the movable internal walls 101, 102, 103, 104 to the modular bunkhouse trailer 100. FIG. 19 shows movable internal walls 101, 102, and 104 removed with only movable internal wall 103 remaining. The individual bunkroom 105 is configured to have one four bed suite 120. This configuration allows for a group of four to have a private accommodation as they are isolated from the next individual bunkroom 106.

### EXAMPLES

Illustrative examples of the mobile bunkhouse trailer disclosed herein are provided below. An embodiment of the mobile bunkhouse trailer may include any one or more, and any combination of, the examples described below.

Example 1 is a trailer with a trailer body defining an interior space. The trailer includes a bunk bed assembly within the interior space such that the bunk bed assembly comprises a lower bed and an upper bed. There are a plurality of barrier walls defining a first individual space that includes the lower bed and a second individual space that includes the upper bed. The trailer has a first door movably attached to the trailer body to access the first individual space and a second door movably attached to the trailer body to access the second individual space. The plurality of barrier walls prevent air flow between the first individual space and the second individual space, thereby isolating the first individual space and the second individual space from each other.

Example 2 includes the subject matter of Example 1, and wherein the trailer body includes a first exterior wall and a second exterior wall, wherein the first door is attached to the first exterior wall of the trailer body and the second door is attached to the second exterior wall.

Example 3 includes the subject matter of Examples 1-2, and wherein the first exterior wall and the second exterior wall extend approximately parallel with respect to each other.

Example 4 includes the subject matter of Examples 1-3, and wherein the lower bed and the upper bed extend approximately transverse to a longitudinal axis of the first exterior wall and the second exterior wall.

Example 5 includes the subject matter of Examples 1-4, and wherein the first door is aligned on the first exterior wall approximately opposite the second door on the second exterior wall.

Example 6 includes the subject matter of Examples 1-5, and wherein the plurality of barrier walls includes a first barrier wall that extends transversely to a longitudinal axis of the lower bed and the upper bed.

Example 7 includes the subject matter of Examples 1-6, and wherein the first barrier wall includes a first portion that extends between a floor and a ceiling of the first individual space and the second individual space.

Example 8 includes the subject matter of Examples 1-7, and wherein the first barrier wall includes a second portion that extends between the floor of the first individual space and the second individual space and the lower bed.

Example 9 includes the subject matter of Examples 1-8, and wherein the plurality of barrier walls includes a second barrier wall that extends approximately parallel to a longitudinal axis of the upper bed between a bottom of the upper bed and the ceiling.

Example 10 includes the subject matter of Examples 1-9, and wherein the plurality of barrier walls includes a third barrier wall that extends approximately parallel to a longitudinal axis of the upper bed between the lower bed and the upper bed.

Example 11 includes the subject matter of Examples 1-10, and wherein the second barrier wall and the third barrier wall combine to extend an entire length of the lower bed and the upper bed.

Example 12 includes the subject matter of Examples 1-11, and further comprising a first step assembly movable between a retracted position within the trailer and an extended position that provides a transition between an egress surface and the first door.

Example 13 includes the subject matter of Examples 1-12, and further comprising a second step assembly movable between a retracted position within the trailer and an extended position that provides a transition between an egress surface and the second door.

Example 14 includes the subject matter of Examples 1-13, and wherein the first step assembly moves in a first direction when moving to an extended position and the second step assembly moves in a second direction when moving to the extended position, wherein the first direction is opposite the second direction.

Example 15 includes the subject matter of Examples 1-14, and further comprising a first return vent within the first individual space to expel air out of the first individual space and a second return vent within the second individual space to expel air out of the second individual space.

Example 16 includes the subject matter of Examples 1-15, and further comprising at least one fresh air intake vent positioned remote from the first return vent and the second return vent to prevent introduction of air expelled out the first return vent and the second return vent from being introduced into the at least one fresh air intake vent.

Example 17 is a trailer with a trailer body defining an interior space. The trailer includes a plurality of bunk bed assemblies within the interior space such that each of the plurality of bunk bed assemblies include a lower bed and an upper bed. There are a plurality of barrier walls associated with each of the plurality of bunk bed assemblies, wherein the plurality of barrier walls define isolated interior spaces between the lower bed and the upper bed for each of the plurality of bunk bed assemblies. A first exterior door is provided that is movably attached to the trailer body to access a first individual space defined by the plurality of barrier walls. The trailer also includes a second exterior door movably attached to the trailer body to access a second individual space defined by the plurality of barrier walls. The plurality of barrier walls prevent air flow between the first individual space and the second individual space, thereby isolating the first individual space and the second individual space from each other.

Example 18 includes the subject matter of Example 17, and wherein the plurality of bunk bed assemblies comprise at least six bunk bed assemblies to provide 12 separate beds within the trailer body, wherein the plurality of barrier walls defines 12 isolated spaces within the trailer body corresponding each of the 12 separate beds.

Example 19 includes the subject matter of Examples 17-18, and further comprising a first set of six doors on a first side of the trailer body, wherein the six doors on the first side of the trailer body are configured to access six respective isolated spaces within the trailer body defined by the plurality of barrier walls.

Example 20 includes the subject matter of Examples 17-19, and further comprising a second set of six doors on a second side of the trailer body spaced apart from the first side, wherein the second set of six doors on the second side of the trailer body are configured to access six respective isolated spaces within the trailer body defined by the plurality of barrier walls.

1. A trailer comprising:
a trailer body defining an interior space;
a bunk bed assembly within the interior space, wherein the bunk bed assembly comprises a lower bed and an upper bed;
a plurality of removable barrier walls defining a first individual space that includes the lower bed and a second individual space that includes the upper bed;
a first door movably attached to the trailer body to access the first individual space;
a second door movably attached to the trailer body to access the second individual space;
a first return vent within the first individual space to expel air out of the first individual space and a second return vent within the second individual space to expel air out of the second individual space;
a first air supply vent within the first individual space to supply conditioned air to the first individual space and a second air supply vent within the second individual space to supply conditioned air to the second individual space, wherein the first air supply vent and the second air supply vent are positioned remote from the first return vent and the second return vent to prevent introduction of air expelled out the first return vent and the second return vent from being introduced into either the first fresh air intake vent or the second fresh air intake vent;
a HVAC unit configured to supply conditioned air to the first air supply vent and the second air supply vent, wherein the first air supply vent and the second air supply vent are fluidly connected with ducting so that conditioned air supplied by the HVAC unit supplies conditioned air into both the first individual space and the second individual space;
wherein the plurality of removable barrier walls prevent air flow between the first individual space and the second individual space, thereby isolating the first individual space and the second individual space from each other; and
wherein the plurality of removable barrier walls can be selectively removed.

2. The trailer of claim 1, wherein the trailer body includes a first exterior wall and a second exterior wall, wherein the first door is attached to the first exterior wall of the trailer body and the second door is attached to the second exterior wall.

3. The trailer of claim 2, wherein the first exterior wall and the second exterior wall extend approximately parallel with respect to each other.

4. The trailer of claim 1, wherein the plurality of removable barrier walls further comprises at least four removable barrier walls.

5. The trailer of claim 1, wherein the plurality of removable barrier walls further comprises at least three removable barrier walls.

6. The trailer of claim 1, wherein the plurality of removable barrier walls further comprises at least two removable barrier walls.

7. The trailer of claim 1, wherein the plurality of removable barrier walls further comprises at least one removable barrier wall.

8. The trailer of claim 1, wherein the plurality of removable barrier walls further comprise a plurality of securement points about the periphery of the plurality of removable barrier walls.

9. The trailer of claim 8, wherein the plurality of securement points about the periphery of the plurality of removable barrier walls further comprise at least five securement points.

10. The trailer of claim 1, wherein the plurality of removable barrier walls includes a first removable barrier wall that extends transversely to a longitudinal axis of the lower bed and the upper bed.

11. The trailer of claim 10, wherein the first removable barrier wall includes a first portion that extends between a floor and a ceiling of the first individual space and the second individual space.

12. The trailer of claim 11, wherein the first removable barrier wall includes a second portion that extends between the floor of the first individual space and the second individual space and the lower bed.

13. The trailer of claim 12, wherein the plurality of removable barrier walls includes a second removable barrier wall that extends approximately parallel to a longitudinal axis of the upper bed between a bottom of the upper bed and the ceiling.

14. The trailer of claim 13, wherein the plurality of removable barrier walls includes a third removable barrier wall that extends approximately parallel to a longitudinal axis of the upper bed between the lower bed and the upper bed.

15. The trailer of claim 14, wherein the plurality of removable barrier walls includes a fourth removable barrier wall that extends approximately parallel to a longitudinal axis of the upper bed between the lower bed and the upper bed.
